(19) United States
(12) Patent Application Publication
(10) Pub. No.: US 2005/0063010 A1
(43) Pub. Date: Mar. 24, 2005

(54) Multiple flow rendering using dynamic content

(75) Inventor: Fabio Giannetti, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/668,958

(22) Filed: Sep. 24, 2003

(51) Int. Cl. G06K 15/02; G06F 17/00

(52) U.S. Cl. 358/1.18; 715/513; 715/517

(57) ABSTRACT

A print run data comprises a first document data, said first document data having at least one unassigned copy hole, said first document data being written in a page description language; and a second document data, said second document data being sized so as to fit into said unassigned copy hole, said second document data being written in a document description language.

### FIELD OF THE INVENTION

The present invention relates to the field of digital publishing.

### BACKGROUND TO THE INVENTION

Known publishing solutions operate either by using a known off set printing press, or by using a digital printing press. With a conventional off set printing press, a master document needs to be copied, and then a run of copies, say 5,000 or 10,000 copies are printed off. Known digital printing presses have an advantage that successive individual print items which are different to each other can be printed, without interrupting the workflow, that is the logical sequence of steps required to perform a printing operation. With the known digital press, the digital master is electronic, and the number of print items in a print run is variable and small print runs from one print item upwards can be accommodated.

Known digital printing presses are capable of printing a print run comprising a plurality of print items, wherein individual print items within the print run are different to each other. Referring to FIG. 1 herein, there is illustrated schematically in perspective view, a known digital printing press.

The introduction of Digital Presses enable creation of more personalized documents and with an increasingly amount of variable data. This change in the way in which high quality full colour documents are designed brought press producers to introduce a new standard to help Graphic Artists (GA), Market Managers (MM) and Databases Administrators (DBA) to integrate their job to obtain the highly customized, variable document capable of modem presses.

This effort, primarily developed inside the PODi (Print on Demand Initiative), led to the introduction of two formats, PPML (Personalized Printing Markup Language) and PPML/T (PPML Templating). The adoption of those two formats help the generation of VDP (Variable Data Print) workflows where the different actors could share design, templates and data. This technology also enables high re-use of assets and the possibility for the Print Shop (PSP) to consume partially fulfilled documents and replace the variable elements very close to the actual rasterizing process.

Referring to FIG. 2 herein, there is illustrated schematically a page of a document written in the known personal printing mark up language (PPML). Conventionally, it is known to prepare documents for printing in a digital printing press, using the known personal printing mark up language (PPML). In the known PPML, a graphic artist may define a number of “copy holes” 200 in a PPML document 201.

The PPML document comprises one or a plurality of pages. Each page has one or more copy holes which can be positioned by a user on the page. Each copy hole is defined by a width a, height, and a 2-dimensional position on a page.

Inside each copy hole there is placed content, for example text content comprising a plurality of lines of text. Consequently, in known PPML work flows (i.e. sequences of steps which are required to perform a print job submitted in PPML), everything is static. All aspects of layout and content are pre-determined and are positioned on the page, including the copy holes, and the content within the copy holes.

A graphic artist designs the PPML page, and then inserts static text and/or objects within the copy holes using a conventional graphic artist package, for example the known ‘Express’ tool from QUARK.

In contrast, extensible style sheet language formatting objects, (“XSL-FO”) belongs to a class of languages known as document description languages, DDL, which are languages which describe whole documents, rather than individual pages. In XSL-FO, there is no concept of one page, but there is a concept of a sequence of pages making up a document, and there is also a concept of where the content will be positioned within a page sequence.

Referring to FIG. 3 herein, there is illustrated schematically an example of a workflow in the known XSL-FO language, comprising a sequence of text, images and tables, extending throughout an XSL-FO document. Text, images and tables may be inserted in sequence as a flow of content (also known as “content flow”) along the document. Referring to FIG. 4 herein, an XSL-FO content flow is fixed as a set of pages in a page description language, by rendering the XSL-FO content flow in a rendering engine. The rendering engine has the capability of marking the XSL-FO content flow into a page sequence. According to the amount of content, the rendering engine determines how many rendered output pages are needed to accomodate the content flow. Using the existing XSL-FO technology, all content is static, and the rendering engine simply produces enough pages to fit the XSL-FO content until all the content flow is rendered.

### SUMMARY OF THE INVENTION

According to a first aspect there is provided a digital printing press capable of extracting extensible style language (XSL) formatting objects from a personal printing mark up language (PPML) work flow.

According to another aspect of the present invention, there is provided a method of printing a print run data comprising at least one individual print item, said method comprising:
laying out at least one document page for said print item, said document page comprising at least one empty copy hole;
generating a second document, said second document having a data content, wherein said second document is dimensioned so as to perform content re-flow within said copy hole; and
merging said second document with said at least one document page to produce said print run, in which said second document appears within said at least one copy hole of said document page.

Other aspects of the present invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically in perspective view, a prior art digital printing press;

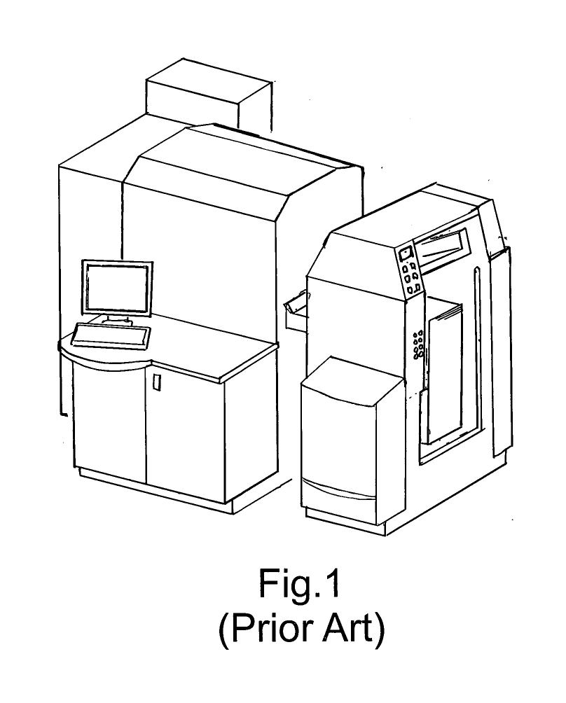

FIG. 2 illustrates schematically a page of a personal printing mark up language (PPML) document;

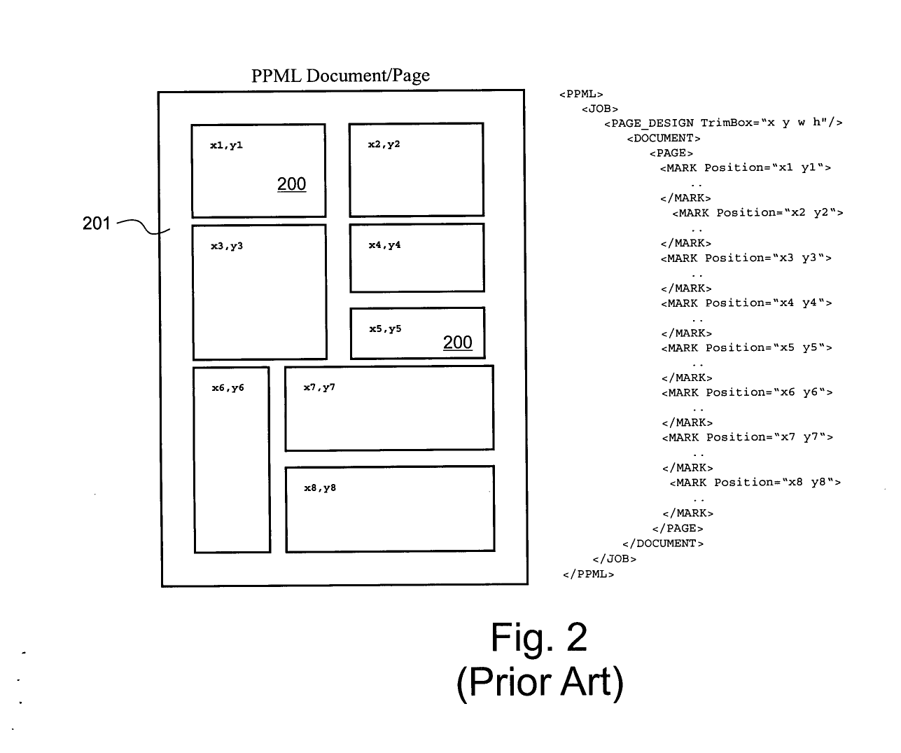

FIG. 3 illustrates schematically a known extensible style language-formatting objects (XSL-FO) document divided into a number of pages;

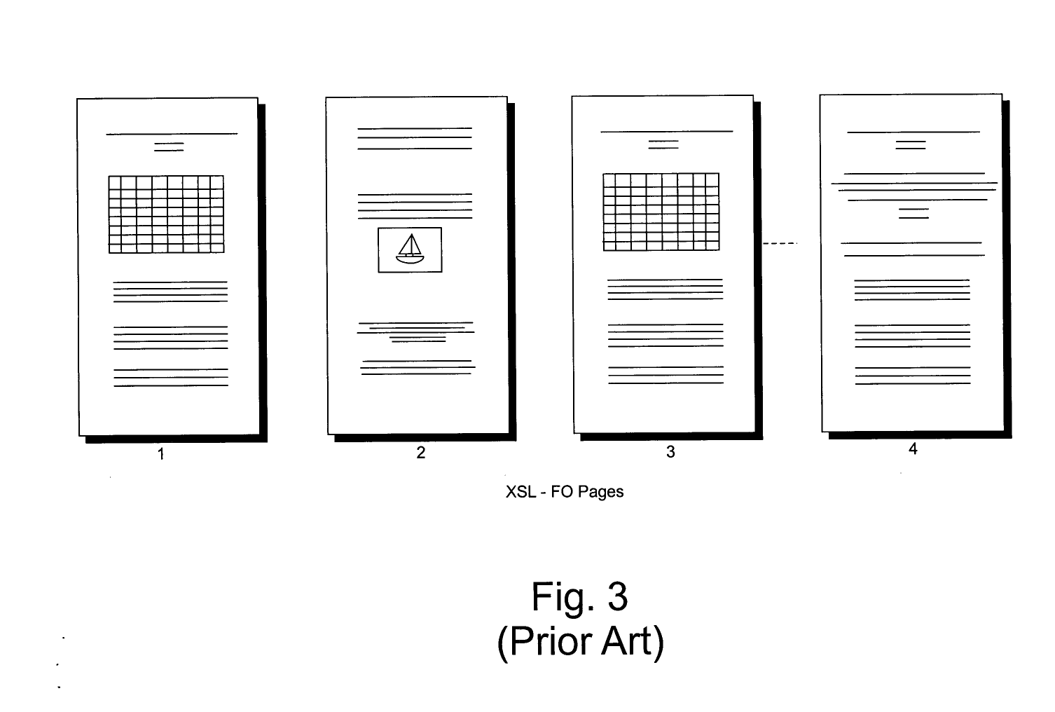

FIG. 4 illustrates schematically a known XSL-FO content workflow through a known rendering engine to produce a plurality of page description language (PDL) rendered pages;

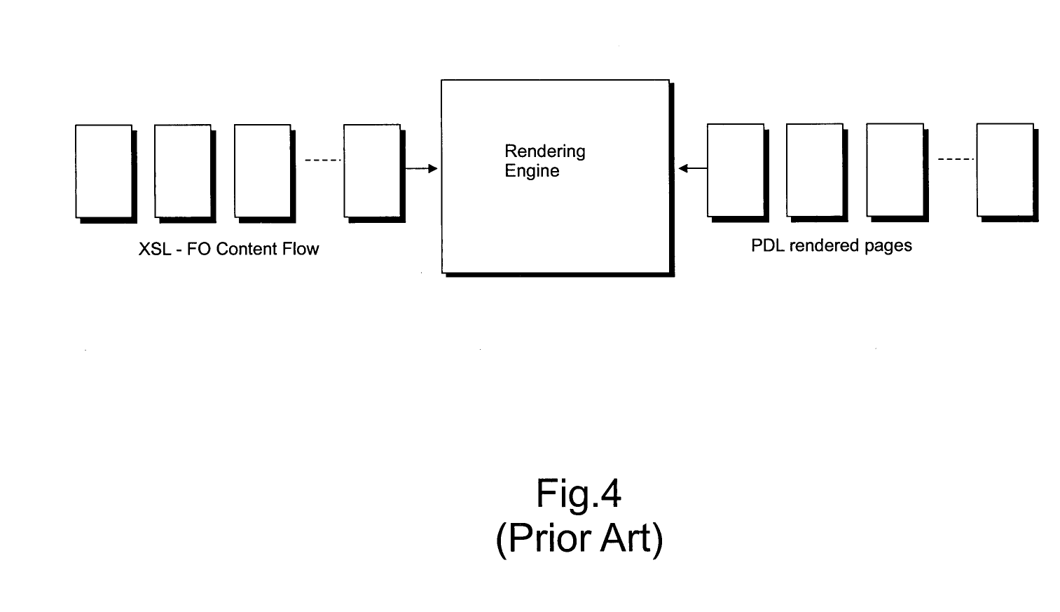

FIG. 5 illustrates schematically an example of a PPML document according to a specific embodiment of the present invention, having one or more copy holes assigned for containing dynamic content;

FIG. 6 illustrates schematically processed steps for creating a document having both fixed content and dynamic content copy holes according to a specific method of the present invention;

FIG. 7 illustrates schematically assignment of an XSL-FO content flow to a document run comprising a plurality of print items defined as PPML documents;

FIG. 8 illustrates schematically processes carried out in a digital printing press for processing a combined PPML and XSL-FO document according to a further specific method of the present invention.

FIG. 9 illustrates schematically an XSL-FO document representing a sequence flow of copy holes;

FIG. 10 illustrates schematically a PPL document in flowable form according to a specific embodiment of the present invention;

FIG. 11 illustrates schematically an XSL-FO code representing a copy hole sequence flow according to a specific embodiment of the present invention;

FIG. 12 illustrates schematically a matching and insertion process carried out by a PPML merger component of a digital printing press;

FIG. 13 illustrates schematically a document description for a flow representation in XSL-FO;

FIG. 14 illustrates schematically an output generated by an extended XSL-FO rendering engine according to a specific embodiment of the present invention;

FIG. 15 illustrates schematically two different cases of flow fulfillment which can be used to avoid leaving empty spaces inside a copy hole;

FIG. 16 illustrates schematically implementation of a PPML merger component as a separate component within a digital printing press;

FIG. 17 illustrates schematically implementation of a PPML merger component as part of a PPML consumer component of a digital printing press; and

FIG. 18 illustrates schematically an example of an overall workflow for printing a print run of print items having variable content from print item to print item, according to a specific embodiment of the present invention.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Specific embodiments and methods disclosed herein combine known technologies to achieve more flexibility in a new and improved digital printing press. The known language technology of personal printing mark up language (PPML) which is a page description language (PDL) is combined with extensible style sheet language for formatting objects (XSL-FO), sometimes known simply as “FO”, which is a document description language (DDL).

The known PPML and XSL-FO languages are conventionally used for very different purposes, and for work in different markets. By combining the known PPML and XSL-FO languages, an advantage can be achieved in a digital publishing set up using a digital press, as will be described herein after.

PPML is a page description language (PDL). In PPML, documents are described in a page by page manner.

A problem addressed by the specific embodiments herein, is how to provide a dynamic content flow to a digital printing press.

In this specification, the term ‘dynamic content’ refers to a variable data content, that is, a content which changes for different print items in a same print run.

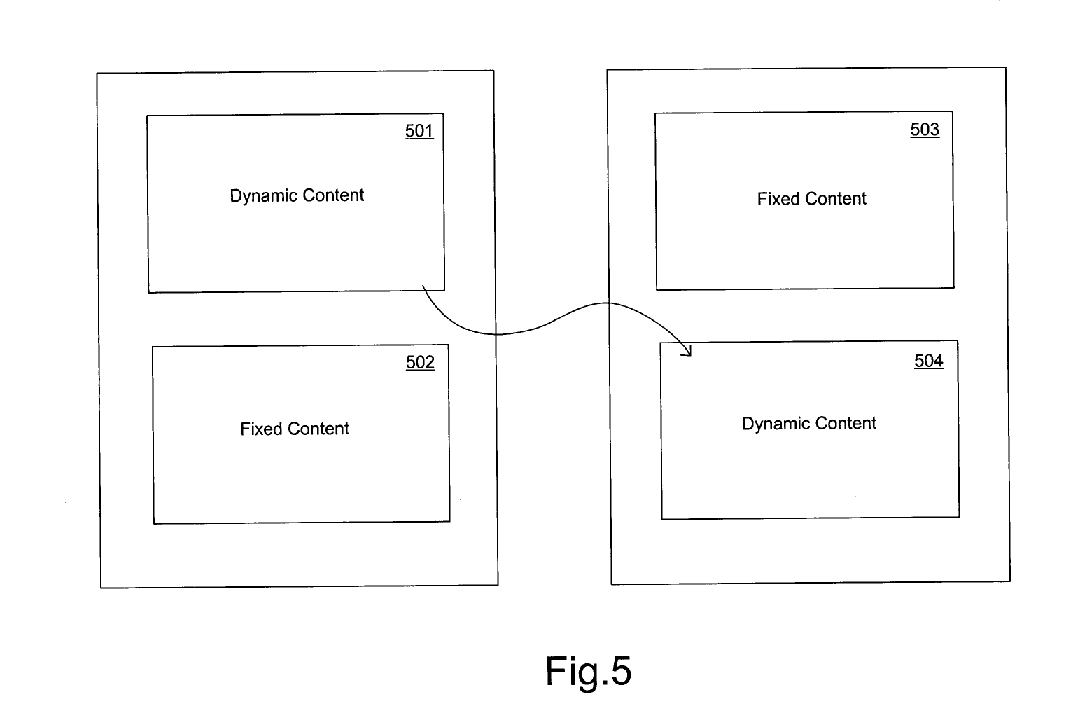

Referring to FIG. 5 herein, there is illustrated schematically an example of a document according to a specific embodiment of the present invention, having copy holes capable of containing dynamic content.

Because the document is intended for high quality digital printing, a graphic artist will design the document. The graphical artist is responsible for defining the document artistically. The graphical artist designs a document having a set of copy holes 501, 502, 503, 504. In the examples shown, there are two copy holes per page in a two page document. In this example, two of the copy holes 502, 503 have fixed content, whereas first and fourth copy holes 501, 504 respectively are set by the graphic artist to have dynamic content. The dynamic content flows from the first copy hole 501 to the fourth copy hole 504.

This is achieved by placing a variable content XSL-FO document inside the first and fourth copy holes, where the page size of the XSL-FO document coincides with the size of the dynamic content copy holes 501, 504.

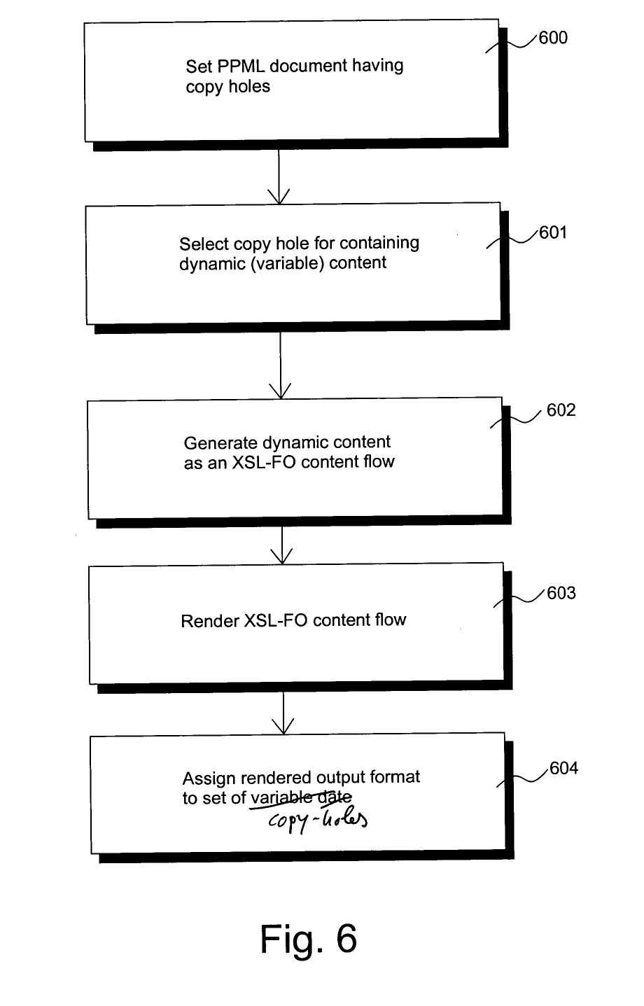

Referring to FIG. 6 herein, there is illustrated schematically process steps for creating a document having fixed content copy holes and dynamic content copy holes, suitable for input to a digital printing press. The process may be implemented as a generic algorithm for placing an XSL-FO document into a copy hole in a document, which then undergoes a process of rendering, to obtain an output. In process 600, a PPML document is set having one or a plurality of copy holes. In process 601, a user selects a set of copy holes and assigns those to contain a dynamic (variable) content. In process 602, a dynamic content is generated as an XSL-FO content flow. In process 603, the XSL-FO content flow is rendered by a rendering engine. In process 604, the rendered output format (for example SVG) is assigned to the set of variable data copy holes, in order to produce a document run comprising a plurality of documents, wherein the content of each document is capable of varying from print item to print item (i.e. individual document to individual document) during the print run.

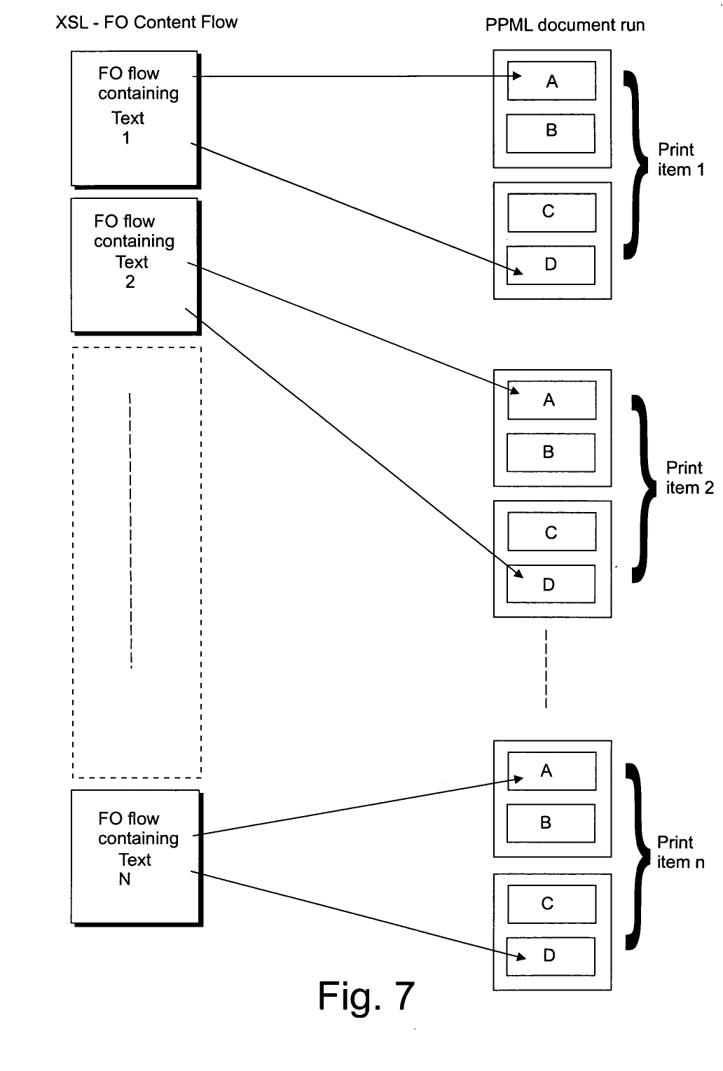

Referring to FIG. 7 herein, there is illustrated schematically assignment of an XSL-FO content flow to a document run comprising a plurality of print items each defined as a PPML document. For each print item defined as a PPML document, a single XSL-FO flow in a single XSL-FO document is assigned to the copy holes of that PPML document. A first print item 700 comprises first and second PPML pages having first to fourth copy holes A-D respectively, wherein the first copy hole A and fourth copy hole D are assigned dynamic content, and second and third copy holes B, C respectively have fixed content. A first XSL-FO portion of text (TEXT 1) is assigned to first and fourth copy holes of a first print item. For the next print item, the second block of text in the second XSL-FO content flow is assigned to the first and fourth copy holes of the second print item, and so on, until an Nth block of text in an Nth XSL-FO content flow is assigned to first and fourth copy holes of the Nth print item in the document run.

Alternatively, if a number of print items 1 to N are all coming out of a same PPML description and all that varies from print item to print item is the dynamic content assigned to the variable data copy holes, then a template for defining the flow of content across pages in an XSL-FO document (“XSL-FO flow template) can be used to generate a new flow of content in an XSL-FO document on the fly, as new customer data comes in, which is assigned to a next successive PPML document. The PPML documents can also be generated from a single PPML template on the fly, provided the static content of the PPML documents do not change from print item to print item.

In the general case, printing a print run comprising at least one individual print item, may comprise laying out at least one PPML document page for the print item, where the document page comprises at least one empty copy hole; generating a second (XSL-FO) document, the second document having a data content, such that the second document is dimensioned so as to perform content re-flow (i.e. the rendering of content previously rendered for one container for another container, typically having different characteristics, so that the content flows in an appropriate manner) within the copy hole of the PPML document page; and merging the XSL-FO second document with the at least one PPML document page to produce the print run, in which the second document appears within the at least one previously empty copy hole of the PPML document page.

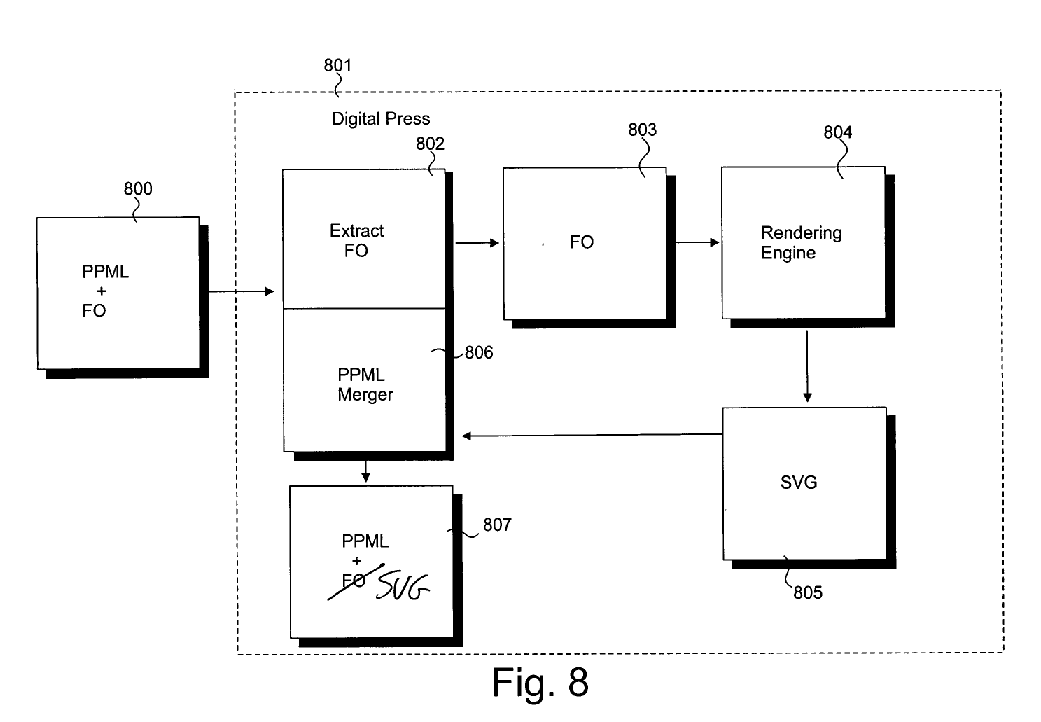

Since there may be a stream of PPML documents and a corresponding stream of XSL-FO documents, a first plurality of PPML document pages may have assigned to them a second plurality of XSL-FO documents, each containing an XSL-FO content flow. The content flow may be dynamic in that it is variable as between different XSL-FO documents. Generating a print run data for and/or printing a print run of a plurality of individual print items, may comprise laying out at least one document page for said print items, said document page comprising at least one empty copy hole; generating at least one second document, said second document having a data content, such that said at least one second document is dimensioned so as to perform content re-flow within said at least one copy hole; and merging said at least one second document with said at least one document page to produce said print run, in which said at least one second document appears within said at least one copy hole of said at least one document page. Referring to FIG. 8 herein, there is illustrates schematically components of a digital printing press according to a specific embodiment of the present invention, capable of processing a document comprising a PPML document and an XSL-FO content flow as described with reference to FIG. 7 herein. A combined PPML and XSL-FO document is presented to the digital press. The digital press extracts the XSL-FO content in the FO extractor 802 to product an FO content flow 803. The FO content extractor may be implemented as an application program running in the digital printing press. The FO content flow 803 is input into rendering engine 804 which outputs a scalable vector graphic (SVG) content flow 805. A PPML merger 806 combines the PPML document with the dynamically changing SVG content to produce a combined PPML plus SVG rasterized document output 807.

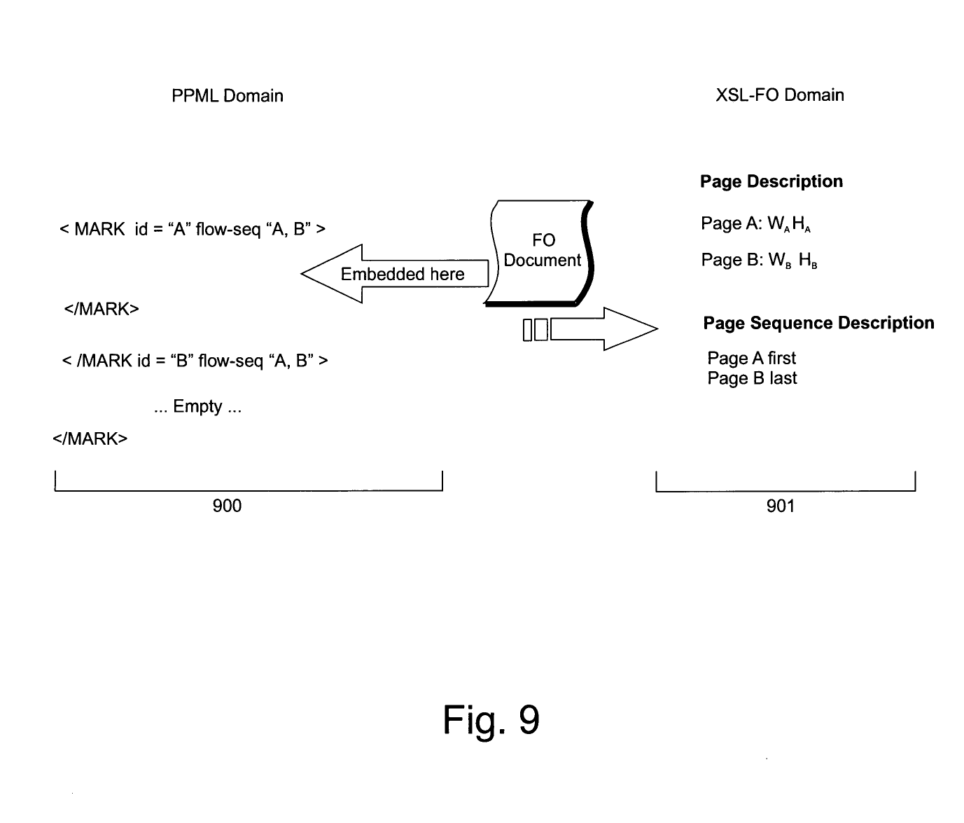

The PPML merger replaces the empty copy holes (i.e. the ones which don't have fixed content) with the SVG rendered content flow, thereby assigning the variable content to the successive print items, and outputting a combined flow of documents having PPML laid out pages and having variable SVG content in the copy holes to which dynamic content is assigned. There may occur situations where an amount of content to fit into the copy holes of a print item is too large to fit. This may result in an error condition. In this case, the press operator may be informed that the combined PPML/XSL-FO document provided cannot be printed, because the amount of content attempted to be fitted into a set of copy holes in a single print item is too large (or alternatively, the amount of content in an XSL-FO document is too much to fit into the combined copy holes of all the documents in a print run). Referring to the combined PPMI/XSL-FO document 800, has a format as shown in FIG. 9. The format has a description which says that the mark with identification “A” has a flow connection with mark “B”, i.e. the two marks are in a sequence of marks identifying sequential copy holes into which a flow of content is to be placed. Also, there is a description that the mark with identification “B” has a flow connection with the mark “A”. This connects the two copy holes “A” and “B” together. The document is placed between the line which identifies MARK “A” as linking with A and B. When the PPML document is abstracted into the XSL-FO flow 901, the XSL-FO document will contain the page description which has page A having width A and height A, and page B having width B and height B. Further, the order in which the pages are to be used are specified as firstly, page A and lastly, page B.

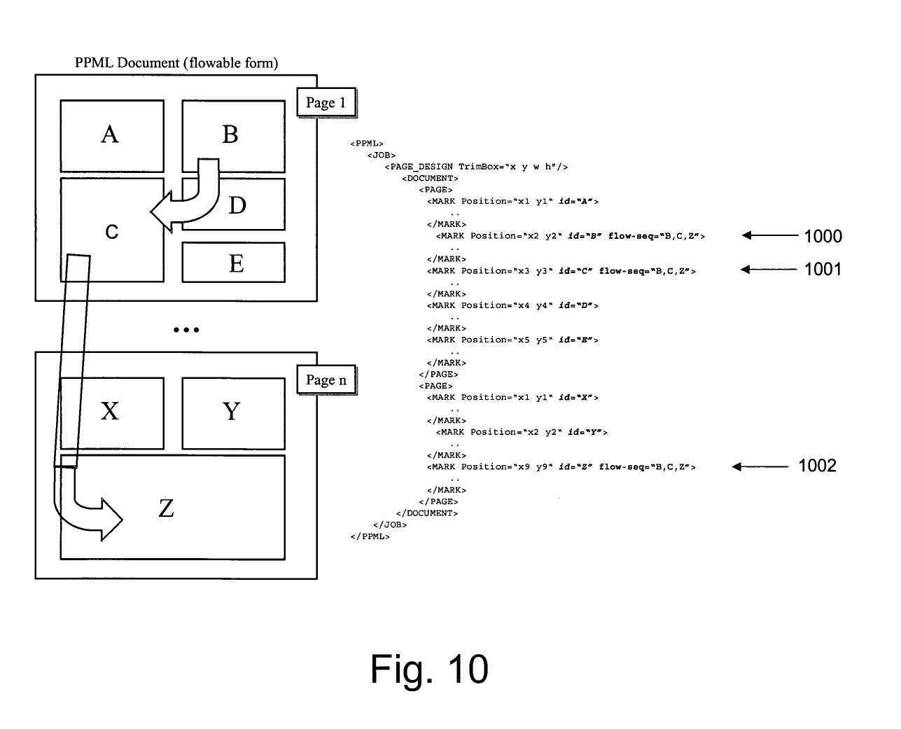

Referring to FIG. 10 herein, there is illustrated schematically a sequence of copy holes across different pages, and its associated description in PPML. Three copy holes B, C, Z have a flow sequence in the order B, C, Z as shown. This is expressed as PPML mark elements 1000, 1001, 1002. The sequence of copy holes could be on the same page, or distributed across a sequence of PPML pages.

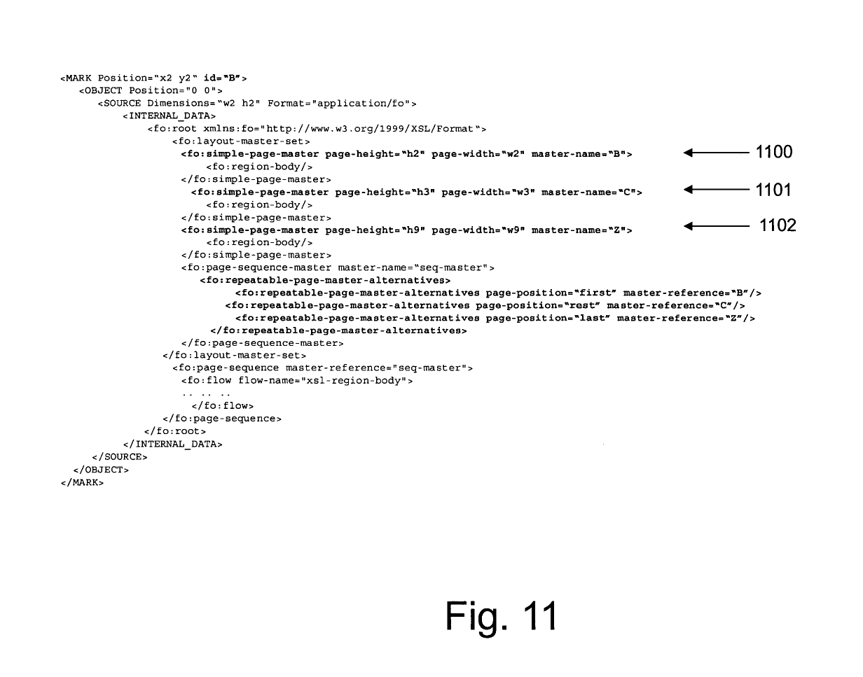

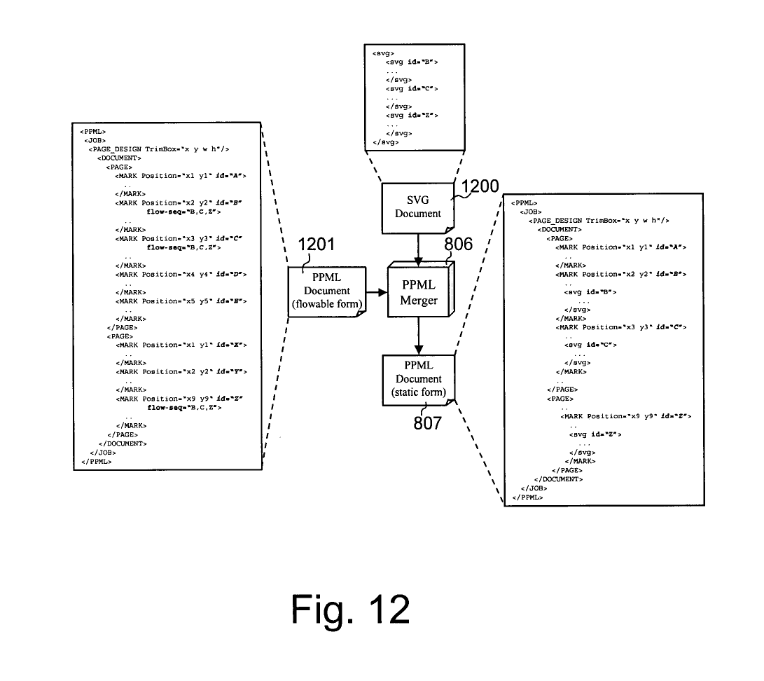

The sequence of copy holes is abstracted out of the PPML page environment, and into an XSL-FO environment. In the example shown in FIG. 10, first, second, and third copy holes B, C, Z are present upon the first PPML page, the first PPML, and the Nth PPML page respectively. However, when abstracted into the XSL-FO environment, the first, second and third copy holes B, C, Z are seen as three consecutive pages in sequence. Referring to FIG. 11 herein, there is illustrated schematically an implemented XSL-FO document representing the sequence of copy holes shown in FIG. 10 herein. At line 1100, the content is assigned to the first copy hole “B”. For each copy hole B, C, Z there is a corresponding respective page definition which defines the height and width of those pages. Lines 1100, 1101, 1102 perform the abstraction of the copy holes from the PPML document. Referring again to FIG. 8, the extractor component 802 extracts the content 803 and sends it to the rendering engine 804, and the result is an SVG data flow 805. Referring to FIG. 12. herein, the SVG document 1200 is merged with a PPML document in flowable form 1201 (i.e. a form which permits the content to flow from one copy hole into another) in the PPML merger 806 resulting in a static form PPML document 807. In the static PPML document, the flow of all of the dynamic content has been resolved. Consequently, one or more copy holes of the PPML document is incorporated into a page of XSL-FO content.

There will now be described in further detail, features of the processing carried out by the digital press described with reference to FIGS. 8 to 18 herein.

PPML: the Underlying Technology

PPML is a Page Description Language that introduces a concept of re-usability at various levels. In PPML, is possible to define re-usable objects and their scope. A PPML consumer will be able to rasterize objects once and reference to them for further use. This speeds up the rasterizing process (i.e. the process of generating a bitmap useable by a print engine to deposit indicia such as toner on a printing medium such as paper) and optimize the press speed. A PPML document is organized as a sequence of documents with a sequence of pages each composed by MARKs (copy-holes) where it is possible to store objects or reference to them.

The objects inside MARKs can be of various nature, in fact, it is possible to store PDF, PS objects as well as images or even SVG (Scalable Vector Graphics) and XSL-FO (eXtensible Stylesheet Language—Formatting Objects). The adoption of the XML (extensible Markup Language) based objects, such as SVG and XSL-FO, provide to PPML the interesting feature to be potentially a PDL entirely expressed using XML dialect. In this case the digital printing press will be able to consume and rasterize an entirely XML based PDL.

Known Limitations

Each PPML copy-hole (MARK) is a sized and absolute positioned rectangular shape and contains content, which could be static and or variable (dynamic), but does not provide any means to execute automatic adjustments to fulfil the content. This is quite problematic if we think to apply dynamic content to those copy-holes without having a fixed number of characters or words since the content is coming out from a database or due to a late binding in the composition process.

There are several situations, where the content could not even pre-determined, such as, information directly connected to user actions or requests, transactional content and internationalization.

In those cases it will be useful to abstract the model bounded areas without any flexibility to at least a collection of area interconnected and able to support content re-flow inside each areas and intra areas.

XSL-FO as Document Description Model for PPML Re-Flow Capabilities

XSL-FO has a concept of a document description model instead of a page description model. In XSL-FO the author will provide a page descriptions, page-sequences masters (or model) descriptions and then content to be rendered inside the page-sequence using the page layouts as indicated. This model is very useful in case you have a content-driven layout and you want to describe the style for each content element leaving to the rendering engine to perform the necessary adjustments, such as the text re-flow, to correctly respect the styling constraints and the pagination/sequence constraints. To maintain the layout-driven approach, and add some flexibility, the PPML layouts (layout-driven) and XSL-FO pagination and flow model (content-driven) can be mixed to obtain a completely new breed of document, which potentially take advantage from both the layout driven and content driven worlds.

A proposed solution embeds or references an XSL-FO document, inside a PPML MARK element. When the PPML Consumer will parse that MARK object it will invoke a customised FOP version which generates the rendered SVG which contains all the line by line positioning as result of the text re-flow and hyphenation.

There will now be described in further detail, extending the FO document description model to achieve multiple flows across PPML copy-holes.

The above abstraction concept of defining a copy-hole as an XSL-FO page and page-sequence can be extended to achieve a page sequence that spans across multiple copy-holes. It is possible to have a sequence of copy-holes in a page, or even in different pages and identify them together creating an abstract model that can be well represented in XSL-FO and then reverse the results back into the pure static page description model.

PPML Required Extensions

To achieve this result the PPML notation is extended and the FO rendering engine behaviour is modified as well as the PPML consumer, which results in a new component, the PPML Merger component.

First of all there are identified with a unique ID, copy-holes all across the document, so that they can be referenced to the formatted content. A sequential relationship between, for instance, the copy-holes B, C and G can be created so that content can flow sequentially between the copy-holes in the designated order. In order to achieve this we need to extend the PPML notation introducing a new attribute that we call “flow-seq”.

This attribute will have as attributes the IDs of the copy-holes involved in accommodating the the content flow and the order inside the list will reflect the ordering of the copy holes and into the XSL-FO pagination abstraction.

FIG. 10 shows an example of the flow of content across copy-holes in a case where all the copy-holes are in the same page.

The flow-seq attribute is referencing the copy-holes B, C, G and this information is replicated for all the three copy-holes. This is done on purpose, since the sequence of copy holes designated to accommodate the content flow here is not tightly related to the order in which the MARKs are serialized inside the PPML PAGE element. Because of this it needs to be ensured that the PPML parser will start to render the object inside the first MARK first, and so in case the PPML parser starts to consider the MARK G before the others it will recognise that G is part of a flow sequence which starts in the MARK B, causing it to retrieve the MARK B and proceed in the right order. It can easily understood that it will be possible to have content flows that span among multiple copy-holes positioned into different pages inside the PPML document.

XSL-FO Document Description Model Abstraction

Once a copy-hole sequence is defined, it can be abstracted into the XSL-FO document description model and create a pagination model that replicates the correct copy-holes order and will provide the text flow across all the various copy-holes regardless of where they are positioned inside the original document.

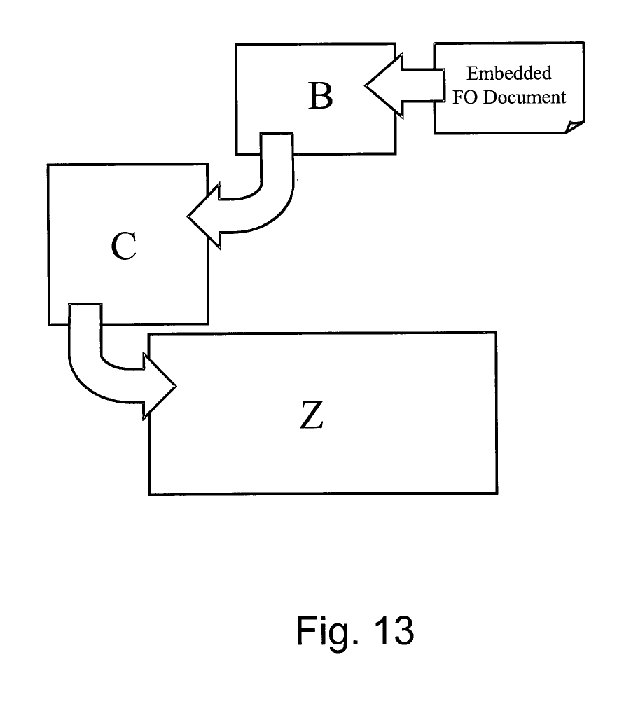

FIG. 13 shows how this abstraction is represented. As seen from FIG. 13, the FO document representing the entire flow will be actually embedded or referenced from the first copy-hole in the sequence. When the graphic artist wishes to create a flow across copy-holes he will identify the copy-holes order and the authoring tool will fix the pagination model in the FO document that implements it. The dynamic content then, could be inserted, during the workflow, inside the FO:flow element. FIG. 11 shows an example of XSL-FO document implementing the B, C, Z sequence of copy-holes.

FO Rendering Engine Extensions

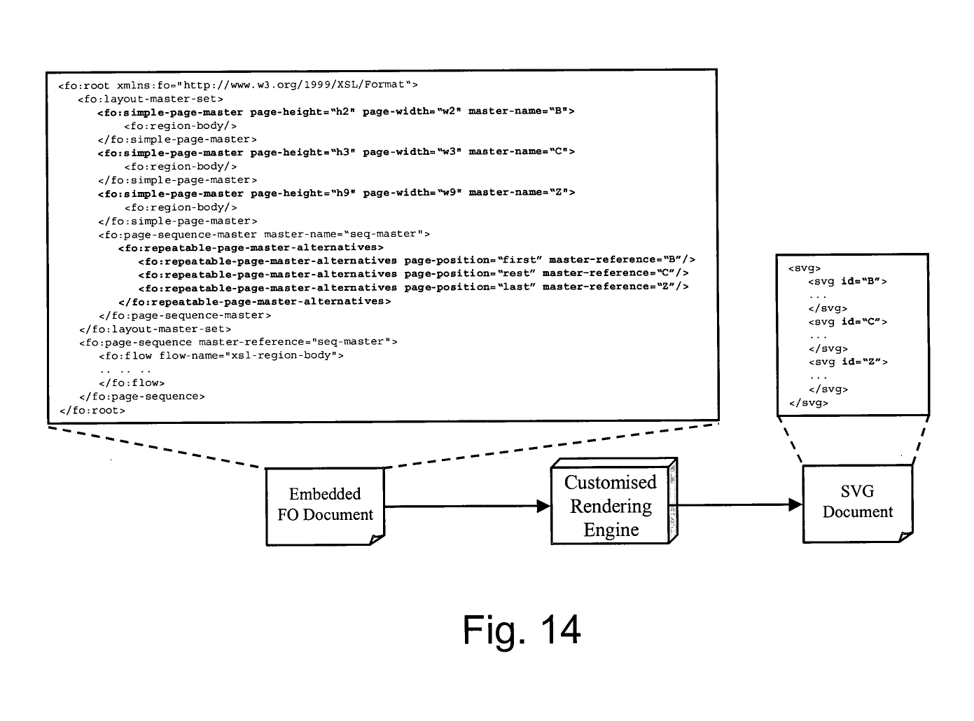

Referring to FIG. 14 herein, there is illustrated schematically an output generated by an extended XSL-FO rendering engine. The XSL-FO rendering engine needs to keep track of the page generation and mark those pages in the generated SVG document. This will enable positioning of the various SVG chunks inside the original PPML document. The current XSL-FO rendering engine used inside the press consumer is an extended version of FOP and the main rendered output used is SVG. This new extension will reference for each SVG document chunks created in the original page which correspond to the PPML copy-hole.

This extension may be easily implementable in FOP since the rendering model is built on an array of pages, created from the same page model, with a nested array of areas. Reversing this array of array in an SVG document will create the output necessary to the PPML merger to allocate the right pages inside the corresponding copy-holes.

PPML Merger

This new component inside the press consumer framework will enable the re-composition of the content flow extracted from inside the original PPML document performing a simple check to find out, from the SVG rendered document, the corresponding chunk and copy-hole. The matching and insertion process is as shown in FIG. 12 herein.

Fulfilment Strategies: the <FALLBACK/> PPML Extension

Having a single or multiple flows in a page or across many pages where the dynamic content is not known until the rendering phase, brings out another problem: the need to fulfil empty areas left by a short amount of dynamic data. In the case the dynamic content amount range varies from fulfilling a single copy-hole to fulfil all the others. It will be desirable to avoid leaving a lot of empty spaces inside the document, but also the graphic artist wants to know which alternative content will be replaced in case the dynamic content is “too short”.

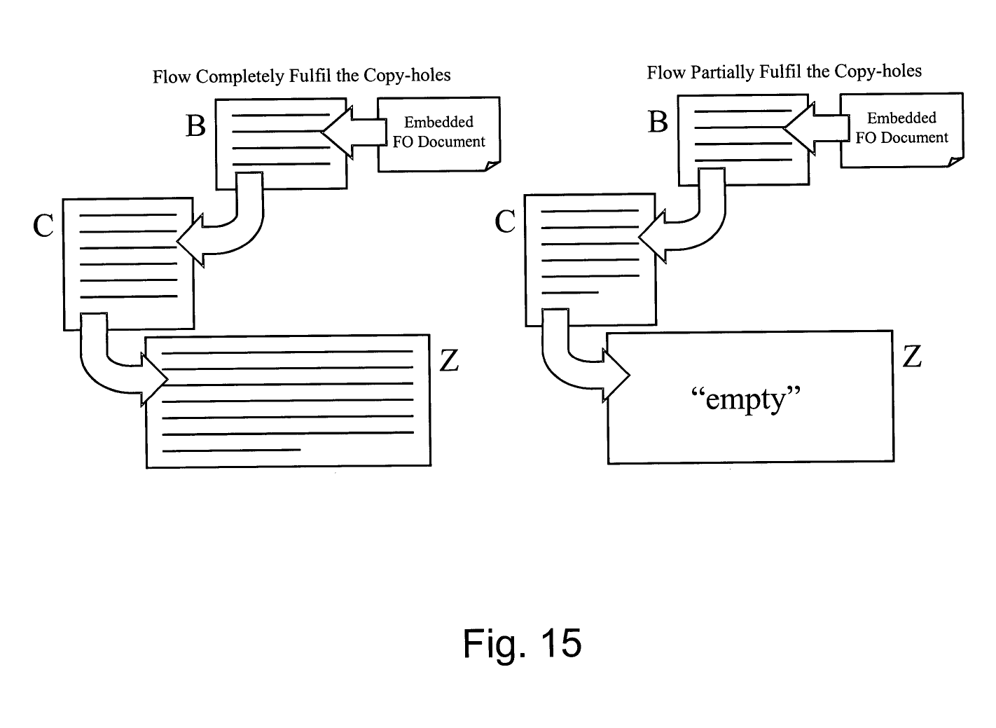

FIG. 15 herein shows schematically two different content flow fulfilment cases, one in which the flow completely fills the copy holes, and one in which the flow partially fills the copy holes, leaving an empty copy hole.

To solve this problem there is introduced a special PPML element, called <FALLBACK> which contains an alternative content to be replaced in case the copy-hole has left blank from the dynamic content flow. Inside the FALLBACK element the graphic artist or a market manager can store some alternative/additional content to be replace on the fly accordingly to the previous dynamic content rendering result and can contain, for instance, an advertisement or some information that are not essential but preferred to have in the case there is enough space left. The PPML Merger can easily spot the situation in which the dynamic content is not capable of filling a copy-hole because the SVG output will be missing of the SVG chunk with that id reference. In this case the PPML Merger will replace inside the copy-hole the FALLBACK content and create a new valid PPML document. FIG. 15 shows in one case, a merging operation when one copy-hole, id=“Z”, has been left empty by the dynamic content rendering.

Workflow Schematics

PPML Merger as a Separate Component

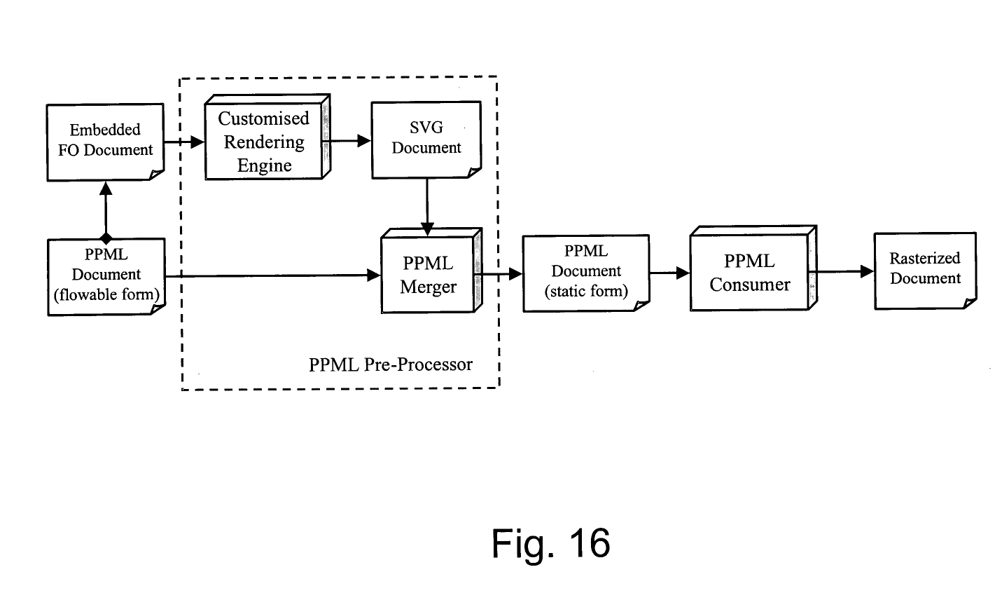

Referring to FIG. 16 herein, there is shown schematically an architectural diagram for a PPML merger as a separate component. The PPML Merger can be seen as a separate component acting like a PPML-Pre Processor because it takes an enhanced PPML document, (referred to here as a PPML “flowable form”) and normalizes it into a standard PPML document, called here PPML “static form”.

PPML Merger as Part of the PPML Consumer

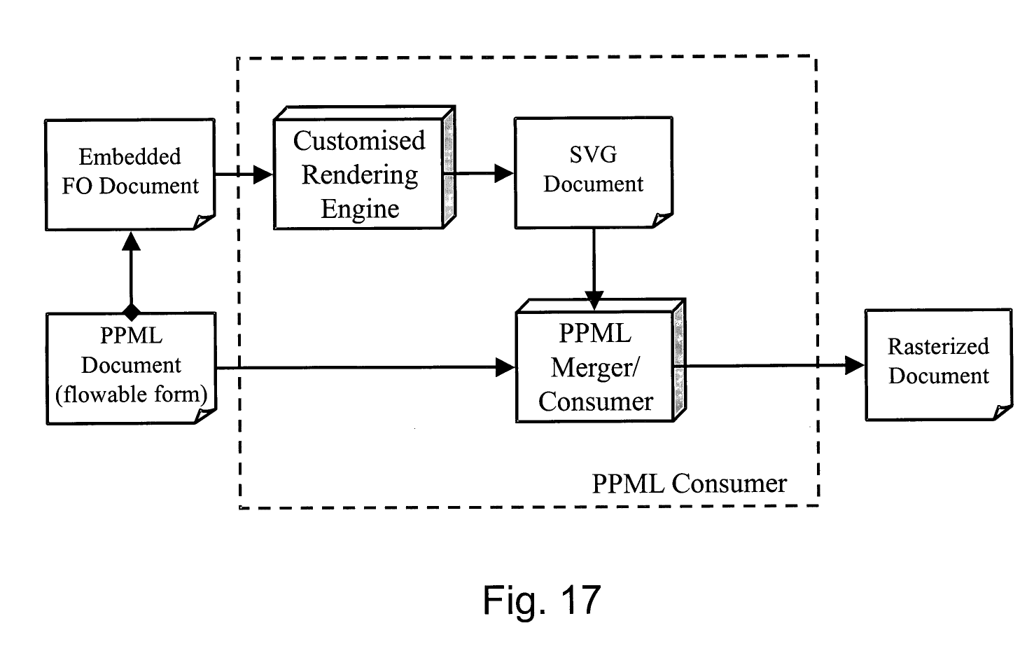

Referring to FIG. 17 herein, there is illustrated schematically a PPML merger as part of a PPML consumer, according to a further specific embodiment. A second architectural solution is to consider the PPML Merger as integral part of the PPML Consumer and let the consumer itself to perform the merging and replacement phase.

The above described technology may be embedded into a workflow which a digital printing press supports.

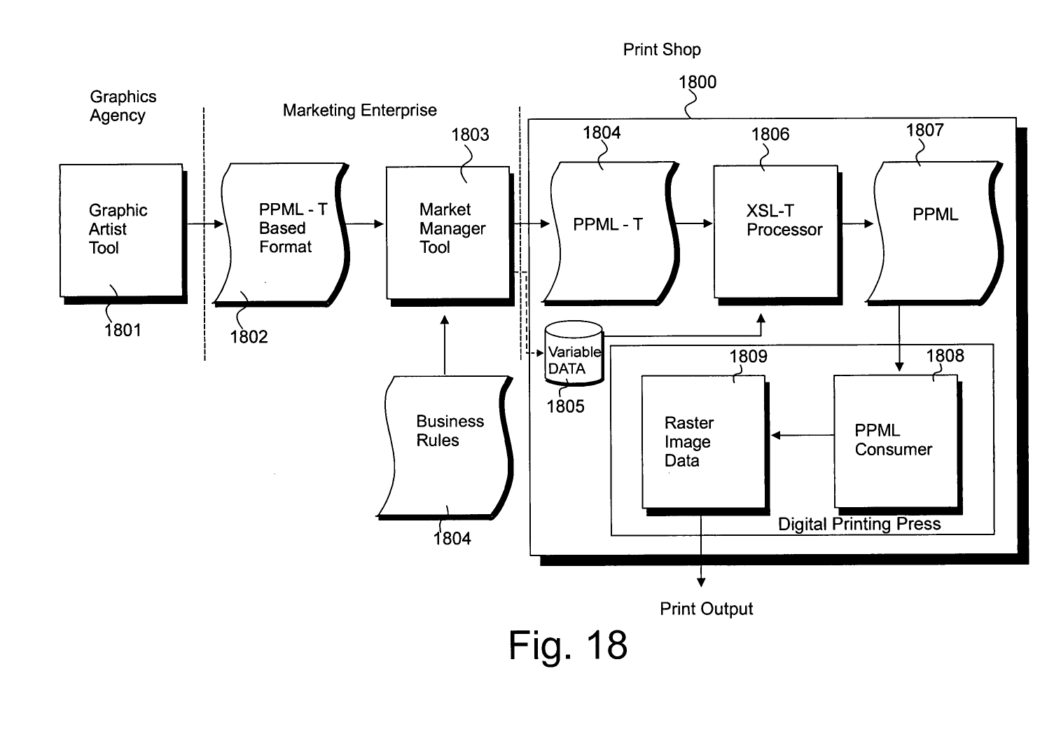

Referring to FIG. 18 herein, there is illustrated schematically a method and apparatus for embedding a PPML/XSL-FO dynamic variable content document into a digital printing press. A print system comprises a digital printing press having a print shop 1800; a graphical artist tool 1801 used by a graphic artist; and a marketing manager tool 1803 operated by a marketing enterprise.

A graphic artist tool 1801, which may be operated by a graphics agency, outputs a PPML-T based format document 1802. The PPML/T (Templating) component is actually performing the “glue” element between the design, data and assets to obtain the final jobs to be consumed by the press. In order to make this model more accessible from graphical artists, a Document Template Format (DTF) is introduced which may provide author with a way to enable templating at design time. DTF is based on PPML/T but add extra features such as the possibility to create themes and multiple layout+style choices. DTF plays a role in the workflow and its characteristics make it suitable for the market manager to apply selection rules to personalize and customise documents to the granularity of the single customer. PPML-T is an extension of PPML which enables documents to run on some customer data sets. The PPML-T based document 1802 is input into a market manager tool 1803 which may apply a set of business rules 1804 to determine which special styling, pictures, or other content as well as the type of content which will be customised to each individual customer or group of customers. Out of the market manager 1803 is output a customised PPML-T file 1804. In the PPML-T document 1804, some of the variable styling and graphics have been fixed. Additionally, there is customer related (variable) data 1805 output from the market manager tool 1803. The PPML-T document, and the variable data 1805 is input into an XSL-T processor 1806 which outputs a PPML file 1807. The PPML file 1807 goes to the PPML consumer component 1808 of the digital printing press which produces the raster image 1809. The raster image can be printed out as print items in a print room.

Specific embodiments according to the present invention may enable print runs having a plurality of print items, each of which may be customized to suit an individual customer or a group of customers, without interrupting the work flow of a digital printing press. Specific embodiments disclosed herein may make it possible to add valuable data content to individual print items within a print run, wherein the data content is dynamic, in that it may change between successive print items in the same print run. Print items may be customized down to the level of customization of each individual print item in a print run, enabling direct one to one marketing, using high quality digital press printing techniques.

1. A digital printing press capable of extracting extensible style language (XSL) formatting objects from a personal printing mark up language (PPML) work flow.

2. A method of printing a print run data comprising:
laying out a document page comprising at least one empty copy hole;
generating a second document, said second document having a data content, wherein said second document is dimensioned so as to enable content re-flow within the copy hole of the document page; and
merging said second document with said at least one document page to produce said print run, in which said second document appears within said at least one copy hole of said document page.

3. A method of printing a print run data comprising a plurality of individual print items, said method comprising:
laying out at least one document page for said plurality of print items, said document page comprising at least one empty copy hole;
generating at least one second document, said second document having a data content, wherein said at least one second document is dimensioned so as to enable content re-flow within said at least one copy hole; and
merging said at least one second document with said at least one document page to produce said print run, in which said at least one second document appears within said at least one copy hole of said at least one document page.

4. The method as claimed in claim 3, comprising:
laying out a plurality of document pages for a plurality of said print items, said plurality of document pages comprising a plurality of empty copy holes;
generating a plurality of second documents, each said second document having a corresponding data content, wherein said plurality of second documents are each dimensioned so as to perform content re-flow within a corresponding said copy hole of a corresponding said document page; and
merging said plurality of second documents with said plurality of document pages to produce said print run, in which said plurality of corresponding data contents appear within said copy holes of said plurality of document pages.

5. The method as claimed in claim 4, wherein said data content is variable as between different said second documents.

6. A method of producing a print run of print items on a digital printing press, said method comprising:
receiving a print data describing said print run, in the form of a first document in a page based format, and a second document in a document based format;
extracting said second document in said document based format;
rendering said second document to produce a rendered second document; and
merging said rendered second document with said first document in said page based format to produce a plurality of print items, wherein said rendered second document appears in at least one copy hole of successive said print items of said print run.

7. A print run data comprising:
a first document data, said first document data having at least one unassigned copy hole, said first document data being written in a page description language; and
a second document data, said second document data being sized so as to fit into said unassigned copy hole, said second document data being written in a document description language.

8. A method of document formatting for digital publishing, said method comprising: designing a plurality of copy holes distributed across at least one PPML page;
abstracting said plurality of copy holes out of said PPML page environment into a second page environment as a sequence, in which each said copy hole is assigned to a corresponding page in said second page environment, and said plurality of copy holes are arranged as sequential pages in said second page environment.

9. The method as claimed in claim 8, wherein said second page environment comprises an extensible style sheet language for formatting objects (XSL-FO) environment.

10. A method of compiling a document for printing by digital printing press, said method including the step of referencing an extensible style sheet language for formatting objects (XSL-FO) document inside a personal printing mark-up language (PPML) MARK element.

11. A method of operating a digital printing press for printing a print run comprising a plurality of print items, said method comprising:
receiving a PPML document having at least one XSL-FO document referenced therein inside a PPML MARK element;
parsing said MARK element;
generating a rendered document which contains line by line positioning of rendered content; and
merging said rendered content into said PPML document.

12. The method as claimed in claim 11, wherein said XSL-FO rendering engine is connected to a PPML consumer.

13. The method as claimed in claim 11, wherein said rendered content comprises an SVG document.

14. The method as claimed in claim 11, wherein a rendered SVG document contains said line by line positioning.

15. A digital printing system adapted to
receive a print data describing a print run in the form of a first document in a page based format and a second document in a document based format;
an extractor for extracting said second document in said document based format;
a rendering engine for rendering said second document to produce a rendered second document; and
a merging component for merging said rendered second document with said first document in said page based format to produce a plurality of print items, wherein said rendered second document appears as a variable content in at least one copy hole of successive said print items of said print run.

16. A digital printing system comprising:
a graphics tool capable of generating a plurality of PPML pages, each having at least one copy hole capable of being assigned variable data;
a manager component capable of abstracting said plurality of copy holes out of said plurality of PPML pages, into a second page environment, said plurality of copy holes being abstracted as a sequence in which each said copy hole is assigned to a corresponding page in said second page environment, and said plurality of copy holes being re arranged as sequential pages in said second page environment.

17. The digital printing system as claimed in claim 16, further comprising a digital printing press capable of receiving a variable content, rendering said variable content and merging said rendered variable content into said plurality of copy holes.

18. A graphics tool capable of generating a plurality of PPML pages, each having at least one copy hole capable of being assigned variable data.

19. A manager component capable of:
abstracting a plurality of copy holes out of a plurality of PPML pages, into a second page environment, said plurality of copy holes being abstracted as a sequence in which each said copy hole is assigned to a corresponding page in said second page environment; and
re arranging said plurality of copy holes as sequential pages in said second page environment.

20. A document comprising:
an extensible style sheet language for formatting objects (XSL-FO) document; and
a personal printing markup language (PPML) document;
wherein said XSL-FO document is referenced inside a PPML MARK element.

21. A method of generating an output document which includes dynamic content comprising the steps of:
designating a plurality of fixed domains within a first source document for the accommodation of dynamic content;
rendering the dynamic content to produce second source document having a sequence of pages in which the dynamic content flows between pages; and
inserting the rendered dynamic content in the fixed domains to produce the output document so that the dynamic content in the second source document flows between fixed domains.

22. A method according to claim 22 wherein the fixed domains are identified in a sequence.

23. A method according to claim 22 wherein at least one fixed domain in the sequence identifies its predecessor in the sequence.

24. A method according to claim 23 wherein the rendered content fills up the domains in the order of the sequence.

25. A method according to claim 24 further comprising the step of generating a bitmap from the output document, and operating a print engine to print the bitmap on a printing medium.

26. A method of generating an output document including the steps of inserting rendered dynamic content which flows between pages in a source document into a sequence of domains in a further source document so that the rendered dynamic content flows between the domains.

27. A method according to claim 26 wherein the source document has a document description format and the further source document has a page description format.

28. A method according to claim 26 wherein the domains in the further source document are of predesignated dimensions.

29. A method according to claim 28 wherein each domain in the sequence identifies its predecessor in the sequence, where one exists.

30. A method according to claim 26 further comprising the steps of generating a bitmap from the output document and operating a print engine to print the bitmap on a printing medium.
